(19) United States
(12) Patent Application Publication
(10) Pub. No.: US 2007/0227378 A1
(43) Pub. Date: Oct. 4, 2007

(54) INK CONTROL APPARATUS, PRINTER, AND PRINTING METHOD

(75) Inventors: Hideaki NAGAI, Hiroshima (JP); Masahito KANEKO, Hiroshima (JP)

Correspondence Address: LOWE HAUPTMAN BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 11/668,802

(22) Filed: Jan. 30, 2007

(30) Foreign Application Priority Data
Mar. 28, 2006 (JP) 2006-089304

(51) Int. Cl. B41F 31/02

(52) U.S. Cl. 101/365

(57) ABSTRACT

An image is created from PPF data and the image is displayed. An operator inputs a total amount of color adjustment as a pre-set value from a color-adjustment-quantity operation screen. An arithmetic unit adjusts a quantity of each ink component to be supplied to the areas based on the pre-set value. The arithmetic unit, for example, adds or subtracts certain values from the standard quantities. An ink supply device correspond to each ink component prints the image on a paper based on the quantity of each ink component adjusted by the arithmetic unit (12).

### CROSS REFERENCE

The present application is based on and claims priority from, Japanese Application Number 2006-089304, filed Mar. 28, 2006, the disclosure of which is hereby incorporated by reference herein in its entirety.

### BACKGROUND OF THE INVENTION

1. Field of the Invention

The present invention generally relates to offset printing, and specifically relates to adjustment of ink supply quantity in offset printing.

2. Description of the Related Art

A typical offset printer includes printing units for four ink colors, i.e., cyan, magenta, yellow, and black, are arranged along a conveyance path of a paper on which matter is to be printed. Each of the printing units includes an ink supply device. The ink supply device includes an ink fountain roller and a plurality of ink keys. An ink supply quantity corresponding to an ink key is adjusted by adjusting a gap (an ink clearance) between that particular ink key and the ink fountain roller. The ink supply quantity adjusted ink is supplied to a printing plate of a plate cylinder via an ink roller group. The ink on the printing plate is then transferred onto a print sheet as a pattern via a blanket cylinder.

In the ink supply device, the ink keys are arrayed along the print width direction of the corresponding printing unit. Each ink key corresponds to a unit area (ink key zone) in the print width direction. Therefore, color adjustment for the printer requires an extremely high skill for setting a variation in a color after separating color adjustment according to the intention of the operator into a process color and converting the variation into an ink clearance taking into account various factors such as an area ratio of a pattern, the number of revolutions of the ink fountain roller, and printing responsiveness.

FIG. 16 is a flowchart of an operation performed by an operator for adjusting an ink supply quantity in an ink control apparatus in a conventional printer. As shown in FIG. 16, when preparation for printing is completed at step S001, the operator performs test print at step S002. At step S003, the operator views the test print and judges whether color adjustment is necessary. If the color adjustment is not necessary, at step S011, the operator carries out commercial printing. On the other hand, if the color adjustment is necessary, at step S004 and subsequent steps, the operator performs color adjustment work.

At step S004, the operator applies color separation to the test print for each of the ink key zones in which color adjustment is necessary and sets increase/decreases of inks of cyan (c), magenta (m), yellow (y), and black (k). At step S005, the operator takes into account an image area ratio of each of the ink key zones. At step S006, the operator sets an opening adjustment quantity of the ink key for each of the ink key zones. At steps S007 to S010, the operator operates each of the ink keys to adjust an opening of the ink key. Thereafter, returning to step S002, the operator performs test print again. At step S003, the operator views the test print and judges whether the color adjustment is necessary. Color adjustment for an image is performed by repeating the work to realize a desired color of the operator.

A conventional ink control apparatus for a conventional printer has been disclosed in Japanese Patent Application Laid-Open Nos. 2000-085107 and 2004-034375 However, in the ink supply device having, for each of the four printing units, a plurality of ink keys for adjusting an ink supply quantity by a unit of a plurality of ink key zones sectioned in a width direction of a print sheet, when one printing unit has, for example, thirty ink keys, there are one hundred twenty ink keys in the four printing units. Thus, it is complicated work for the operator to operate the one hundred twenty ink keys to perform color adjustment. Moreover, for the operation of the ink keys for performing color adjustment for an image, as described above, it is necessary to take into account various factors such as an area ratio of a pattern, the number of revolutions of the ink fountain roller, and pint responsiveness. Therefore, the operation requires an extremely high skill and a heavy work load is applied to the operator.

In the ink-supply-quantity setting device disclosed in Japanese Patent Application Laid-Open No. 2000-085107, individual setting switches are provided in association with a plurality of ink supply devices. When a set value is inputted by one individual setting switch in a right alignment mode, a value of the individual setting switch on the right side thereof is set in association with the input of the set value. In this case, an operation time for the individual setting switches is reduced. However, when color adjustment is to be performed, it is necessary to operate all the individual setting switches. Thus, it is impossible to solve the problem of complicated setting in the color adjustment work and reduce the work load on the operator.

In the printer disclosed in Japanese Patent Application Laid-Open No. 2004-034375, key operation switches for adjusting openings of respective ink keys are displayed on a display screen in a control panel of a touch panel system. When the operator operates a changeover switch, the key operation switches and a pattern of a print being printed are simultaneously displayed. However, since the operator operates a large number of the ink keys to perform color adjustment for the pattern of the print, the operator has to carry out complicated work.

Thus, there is a need of a technology that allows color adjustment to be performed easily.

### SUMMARY OF THE INVENTION

It is an object of the present invention to at least partially solve the problems in the conventional technology.

According to an aspect of the present invention, an ink control apparatus includes an image display unit that displays a print pattern image based on image information; an area selecting unit that selects a target ink area where color adjustment is to be performed from the image displayed by the image display unit; a setting unit that sets a color adjustment quantity for the target ink area; a quantity display unit that displays, for each of ink areas, the color adjustment quantity set by the setting unit; and a changing unit that changes, based on the color adjustment quantity displayed by the quantity display unit, an ink supply quantity in the ink area selected by the color-adjustment-ink-area selecting unit.

According to another aspect of the present invention, a printer includes an ink supply unit that is capable of adjusting an ink supply quantity for each of ink areas sectioned in a print width direction; an image display unit that displays a print pattern image based on image information; an area selecting unit that selects an ink area where color adjustment is performed from the image displayed by the image display unit; a setting unit that sets a color adjustment quantity for the ink area selected by the area selecting unit; a quantity display unit that displays, for each of the ink areas, the color adjustment quantity set by the setting unit; and an changing unit that changes, based on the color adjustment quantity displayed by the quantity display unit, an ink supply quantity in the ink area selected by the area selecting unit.

According to still another aspect of the present invention, a printing method includes first displaying including displaying a print pattern image based on image information; selecting a target ink area where color adjustment is to be performed from the image displayed at the first displaying; setting a color adjustment quantity for the target ink area; second displaying including displaying, for each of ink areas, the color adjustment quantity set at the setting; and changing, based on the color adjustment quantity displayed at the second display, an ink supply quantity in the target ink area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an operation unit of an ink control apparatus according to a first embodiment of the present invention;

FIG. 2 is an external view of the ink control apparatus shown in FIG. 1;

FIG. 3 is a block diagram of the ink control apparatus shown in FIG. 1;

FIG. 4 is a schematic for explaining ink supply quantity control performed by the ink control apparatus shown in FIG. 1;

FIG. 5 is a graph of a variation in an ink clearance with respect to an image area ratio;

FIGS. 6 and 7 are graphs for explaining a collective adjustment method for a density variation;

FIG. 8 is a flowchart of ink supply quantity control by the ink control apparatus shown in FIG. 1;

FIG. 9 is a schematic of an offset printer according to the first embodiment;

FIG. 10 is a schematic of an operation unit of an ink control apparatus according to a second embodiment of the present invention;

FIG. 11 is a schematic of the ink control apparatus in the printer according to the second embodiment;

FIG. 12 is a flowchart of an ink supply quantity control performed by the ink control apparatus shown in FIG. 11;

FIG. 13 is a schematic of an operation unit of an ink control apparatus according to a third aspect of the present invention;

FIG. 14 is a flowchart of an ink supply quantity control performed by the ink control apparatus sshown in FIG. 13; and

FIG. 15 is a flowchart of an ink supply quantity control performed by a conventional ink control apparatus.

### DETAILED DESCRIPTION OF THE PREFERRED EMBODIMENTS

Exemplary embodiments according to the present invention are explained in detail below with reference to the accompanying drawings. The present invention is not limited by the following embodiments.

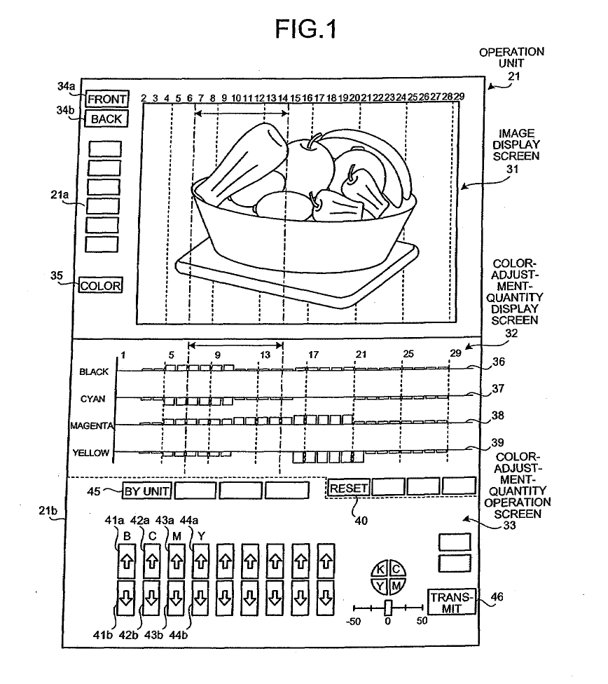

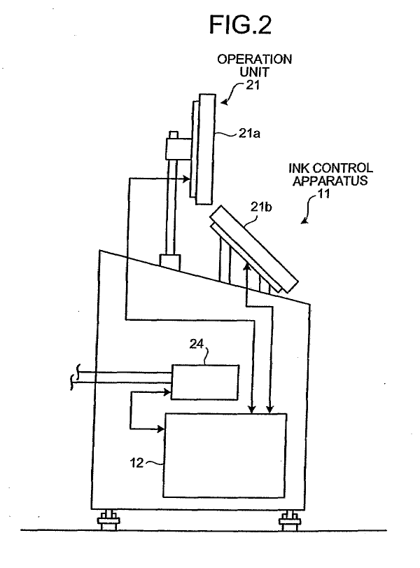

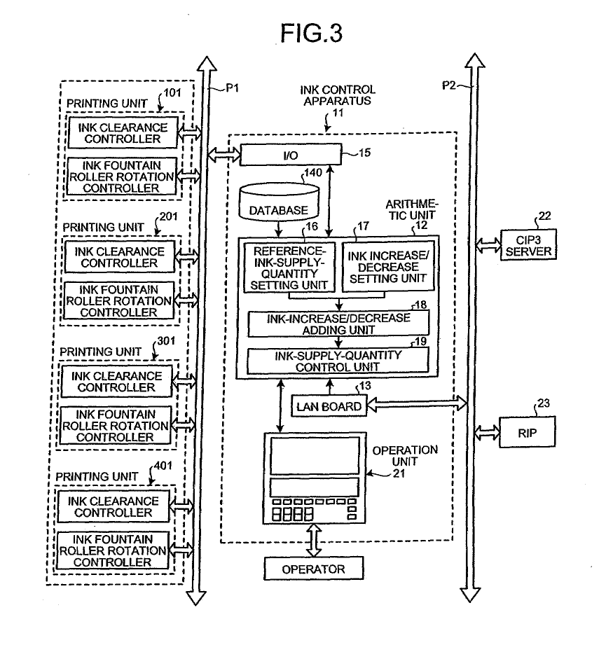

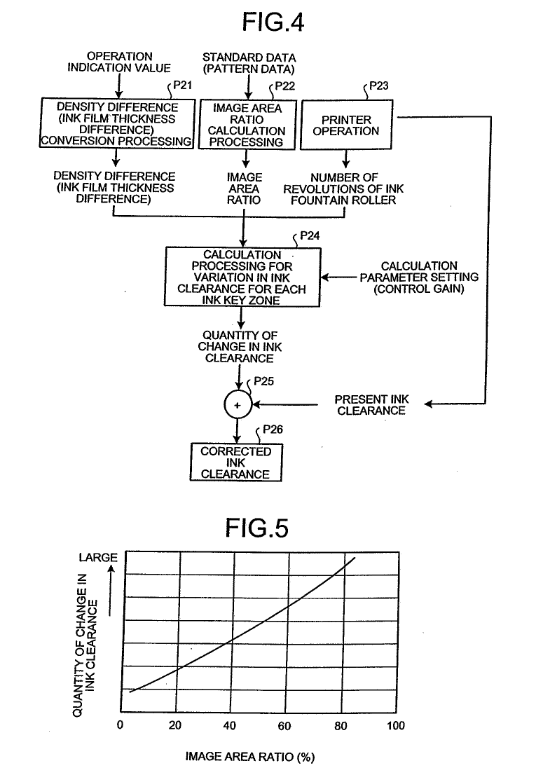

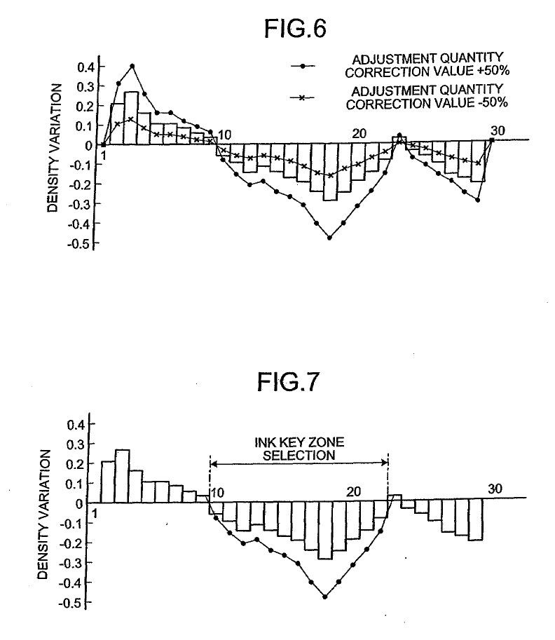

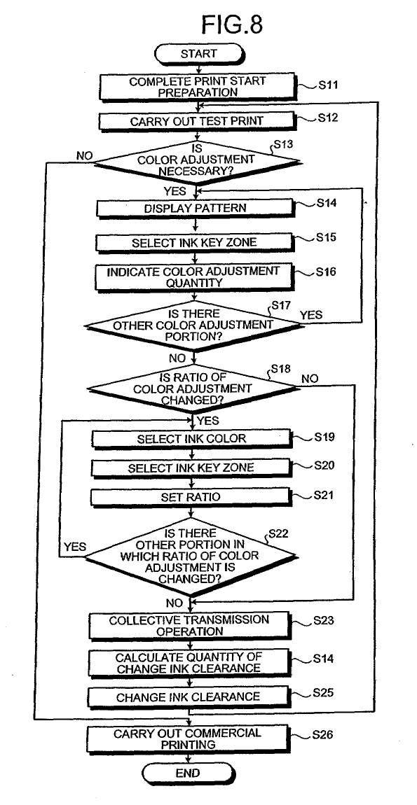

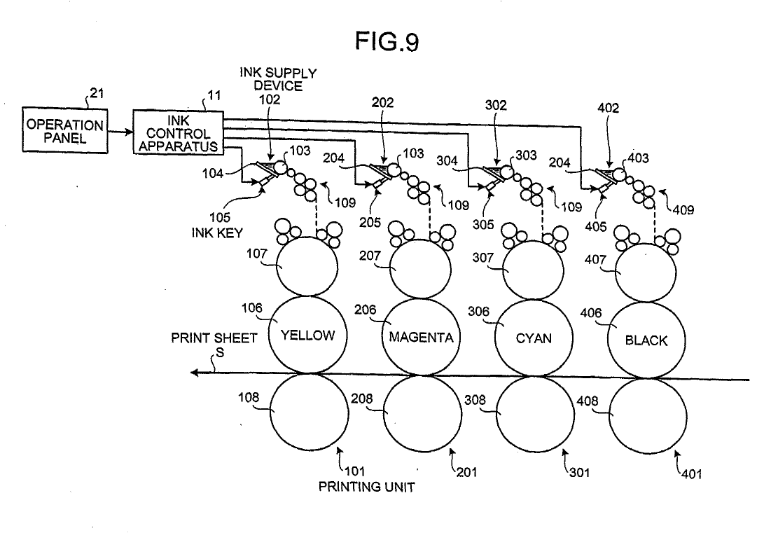

FIG. 1 is a schematic of an operation unit of an ink control apparatus according to a first embodiment of the present invention. FIG. 2 is an external view of the ink control apparatus. FIG. 3 is a block diagram of the ink control apparatus. FIG. 4 is a process diagram of ink supply quantity control for each of ink key zones of the ink control apparatus. FIG. 5 is a graph of a variation in an ink clearance with respect to an image area ratio. FIGS. 6 and 7 are schematics for explaining a collective adjustment method for a density variation. FIG. 8 is a flowchart of an ink supply quantity control performed by the ink control apparatus. FIG. 9 is a schematic of an offset printer to which the ink control apparatus.

In the offset printer to which the ink control apparatus according to the first embodiment are applied, as shown in FIG. 9, printing units 101, 201, 301, and 401 are set for cyan, magenta, yellow, and black as ink colors, respectively, along a conveyance path for a print sheet S. Ink supply devices 102, 202, 302, and 402 are provided in the printing units 101, 201, 301, and 401, respectively. The ink supply devices 102, 202, 302, and 402 have ink fountain devices including ink fountain rollers 103, 203, 303, and 403 and ink blades 104, 204, 304, and 404, respectively. Further, the ink supply devices 102, 202, 302, and 402 have ink keys 105, 205, 305, and 405 capable of adjusting gaps (ink clearances) between the ink fountain rollers 103, 203, 303, and 304 and the ink blades 104, 204, 304, and 404 using adjustment screws. In the case of this embodiment, a plurality of the ink keys 105, 205, 305, and 405 are provided in a print width direction. The ink keys 105, 205, 305, and 405 adjust an ink supply quantity for each ink area as a width unit of the ink keys 105, 205, 305, and 405, i.e., each of ink key zones in this embodiment. In an apparatus in which ink keys is divided at a very small width, one ink area and a plurality of ink key zones may be associated with each other to adjust an ink supply quantity, for example, ink keys may be selected as a set.

Blanket cylinders 106, 206, 306, and 406 and plate cylinders 107, 207, 307, and 407 are arranged above the conveyance path for the print sheet S. On the other hand, impression cylinders 108, 208, 308, and 408 are arranged below the conveyance path for the print sheet S. Ink roller groups 109, 209, 309, and 409 are arranged between the ink supply devices 102, 202, 302, and 402 and the plate cylinders 107, 207, 307, and 407. Therefore, inks whose quantities are adjusted by the ink keys 105, 205, 305, and 405 of the ink supply devices 102, 202, 302, and 402 are properly kneaded by the ink roller groups 109, 209, 309, and 409 to form thin films. Then, the inks are supplied to printing surfaces of the plate cylinders 107, 207, 307, and 407. The inks adhering to the printing surfaces are transferred onto the print sheet S as patterns via the blanket cylinders 106, 206, 306, and 406.

In the offset printer according to this embodiment constituted as described above, the four printing units 101, 201, 301, and 401 have the ink supply devices 102, 202, 302, and 402, respectively. The ink keys 105, 205, 305, and 405 provided in association with the printing units can adjust an ink supply quantity for each of a plurality of (in this embodiment, thirty) ink key zones sectioned in the print width direction. In this embodiment, in applying color adjustment to a test print, when an operator inputs an indication value for color adjustment, the ink keys 105, 205, 305, and 405 automatically calculate an increase/decrease for each of ink components of all ink key zones (ink areas) in which color adjustment is performed. The ink keys 105, 205, 305, and 405 add the increase/decrease for each of the ink components to a supply quantity for each of the ink components that are set based on printing reference data (image information) and set an ink supply quantity for each of the ink components.

In the apparatus structure of the ink control apparatus in the offset printer according to this embodiment, as shown in FIGS. 2 and 3, an ink control apparatus 11 is connected to the printing units 101, 201, 301, and 401 via a first parallel path line P1. The ink control apparatus 11 is capable of controlling ink clearances set by the ink keys 105, 205, 305, and 405 (ink clearance controllers), the numbers of revolutions of the ink fountain rollers 103, 203, 303, and 403 (ink fountain roller rotation controllers), and the like. The ink control apparatus 11 has an arithmetic unit 12 as a color-adjustment-quantity setting unit that sets a color adjustment quantity for each of the ink key zones. A LAN board 13, a database 140, and an input/output port 15 are connected to the arithmetic unit 12. The arithmetic unit 12 has a reference-ink-supply-quantity setting unit 16, an ink-increase/decrease setting unit 17, an ink increase/decrease adding unit 18, and an ink-supply-quantity control unit 19. In this embodiment, the ink-increase/decrease setting unit 17, the ink increase/decrease adding unit 18, and the ink-supply-quantity control unit 19 constitute an ink-supply-quantity changing unit.

The ink control apparatus 11 has an operation unit 21 with which the operator is capable of operating the arithmetic unit 12 and the like from a remote location. The operation unit 21 includes upper and lower two touch panels 21a and 21b. The operation unit 21 has a display function (display means) for displaying images on touch panels 21a and 21b based on print production format (PPF) data as print reference data and a color adjusting unit selecting function (color-adjustment-ink-area selecting means) for selecting, from the image displayed, a plurality of ink key zones in which the operator selects and operates the touch panels 21a and 21b with a finger tip to perform color adjustment.

The ink control apparatus 11 is connected to a CIP3 (cooperation for integration of prepress, press, postpress) server 22 and a raster image processor (RIP) 23 via a second parallel path line P2. To set an ink supply quantity of the offset printer, the CIP3 server 22 outputs PPF data including an image area ratio of a print image to the ink control apparatus 11 through the second path line P2. The RIP 23 replaces print image data with halftone dot data. The RIP 23 passes the halftone dot data to the CIP3 server 22 to create PPF data. In FIG. 2, a hub 24 is connected to the arithmetic unit 12 and the parallel path lines P1 and P2 are connected to the hub 24.

As shown in FIGS. 1 to 3, the operation unit 21 is a display of a touch panel type. An operator is capable of operating the operation unit 21 by touching a screen thereof with a finger tip. The operation unit 21 has an image display screen 31 that displays a print pattern image based on the PPF data by sectioning the print pattern image into ink key zones, a color-adjustment-quantity display screen 32 that displays a set color adjustment quantity for each of the ink key zones, and a color-adjustment-quantity operation screen 33 that displays the color adjustment quantity.

The image display screen 31 can display a print image based on the PPF data. In this case, the respective ink keys 105, 205, 305, and 405 of the ink supply devices 102, 202, 302, and 402 adjust an ink supply quantity for each of thirty ink key zones sectioned in the print width direction. Thus, supplementary lines for sectioning the print image into the thirty ink key zones are displayed and ink key zone numbers (No. 1 to 30) are displayed on the image display screen 31. In a side part of the image display screen 31, sheet selection switches 34a and 34b for selecting the front and the back of a print sheet and a color selection switch 35 for displaying an image with one of black, cyan, magenta, and yellow as four ink colors are provided.

Therefore, for example, when an image of a large number of fruits in a basket is displayed on the image display screen 31 and the operator desires to adjust a color of a specific fruit in the image of the fruits, the operator can set ink key zones, in which color adjustment is performed, by touching the ink key zones No. 7 to 14, in which the fruit is present, with a finger tip to select the ink key zone.

In the color-adjustment-quantity display screen 32, four display sections 36, 37, 38, and 39 that display a color adjustment quantity for each of the ink key zones of the image are provided in association with black (K), cyan (C), magenta (M), and yellow (Y) as the four ink colors. In this case, horizontal lines in the respective display sections 36, 37, 38, and 39 are the last adjustment reference values, increases in color adjustment quantities to be adjusted this time are displayed as bar graphs extending upward, and decreases in the color adjustment quantities are displayed as bar graphs extending downward. Reset switches 40 for resetting adjustment quantities of the adjusted respective ink colors to zero are provided below the color-adjustment-quantity display screen 32. In the color-adjustment-quantity display screen 32, as in the image display screen 31, it is possible to set ink key zones in which color adjustment is performed.

Eight adjustment switches 41a, 41b, 42a, 42b, 43a, 43b, 44a, and 44b for setting color adjustment quantities (increases or decreases) of black (K), cyan (C), magenta (M), and yellow (Y) as the four ink colors are provided in the color-adjustment-quantity operation screen 33. Switches by unit 45 are provided in an upper part of the color-adjustment-quantity operation screen 33. A transmission switch 46 is provided in a side part of the color-adjustment-quantity operation screen 33.

Therefore, when ink key zones in which color adjustment is performed are set in the image display screen 31 (or the color-adjustment-quantity display screen 32), the operator can input an indication value (an increase value or a decrease value) of color adjustment for each of the ink colors by touching any one of the adjustment switches 41a, 41b, 42a, 42b, 43a, 43b, 44a, and 44b of the color-adjustment-quantity operation screen 33. Then, according to the operation of any one of the adjustment switches 41a, 41b, 42a, 42b, 43a, 43b, 44a, and 44b, the indication value, i.e., an increase/decrease for each of black (K), cyan (C), magenta (M), and yellow (Y) as the ink components is displayed on the color-adjustment-quantity display screen 32. In this case, when color adjustment work for each of ink key zones selected is performed a plurality of times, a color adjustment quantity added with the increase/decrease is displayed on the color-adjustment-quantity display screen 32. In other words, a total quantity of color adjustment quantities for the ink components is displayed on the color-adjustment-quantity display screen 32. The operator can collectively transmits the total quantity of the color adjustment quantities displayed on the color-adjustment-quantity display screen 32 to the arithmetic unit 12 by operating the transmission switch 46.

In this embodiment, when a plurality of key zones are selected as described above and identical indication values for color adjustment are collectively set for the ink key zones selected, different optimum color adjustment is automatically set for each of the ink key zones. In other words, even if the identical indication value for color adjustment is set for the ink key zones, since an image area ratio is different for each of the ink key zones, a different optimum ink supply quantity, i.e., ink clearance is set according to this image area ratio and the number of revolution of the ink fountain roller.

As shown in FIG. 4, in a processing block P21, the ink control apparatus subjects, based on the indication value inputted by the operator through the color-adjustment-quantity operation screen 33, a density difference between the indication value and a present density of an ink color (an ink film thickness) to conversion processing. In a processing block P22, the ink control apparatus calculates an image area ratio for each of the ink key zones based on the PPF data. In a processing block P23, the ink control apparatus outputs the numbers of revolutions of the ink fountain rollers in the ink supply devices 102, 202, 302, and 402.

In a processing block P24, the ink control apparatus calculates a variation in an ink clearance for each of the ink key zones. In this case, the ink control apparatus sets a control gain according to a parameter table set in advance using image area ratios and the numbers of revolutions of the ink fountain rollers and calculates a variation in an ink clearance using the density difference and the control gain. In this embodiment, this calculation method is formed as a map shown in FIG. 5. The ink control apparatus sets a variation in an ink clearance with respect to an image area ratio using this map. Thereafter, in a processing block P25, the ink control apparatus adds the variation in an ink clearance set to a present ink clearance to set a corrected ink clearance in a processing block P26.

In this processing for setting an ink clearance, in this embodiment, the ink control apparatus sets a variation in an ink clearance with respect to an image area ratio using the map set in advance. However, the ink control apparatus may calculate a variation in an ink clearance with an equation according to a parameter table using the image area ratio, the number of revolutions of the ink fountain roller, and the like.

In this embodiment, it is possible to change a ratio of a color adjustment quantity adjusted for each of the ink colors. The color-adjustment-quantity operation screen 33 includes a color selection switch 47 for selecting an ink color and a ratio-change bar switch 48 for changing a ratio of a color adjustment quantity for each of the ink colors.

Therefore, in the color-adjustment-quantity operation screen 33, the operator selects one of black (K), cyan (C), magenta (M), and yellow (Y) as the four ink components using the color selection switch 47 and operates the ratio-change bar switch 48. In this way, the operator can change a ratio of a color adjustment quantity for the selected ink color. In this case, as shown in FIG. 6, when an ink key zone is not selected, the operator can adjust a color adjustment quantity indicated by a bar graph in the figure to increase or decrease the quantity by 50% as indicated by a line graph by performing the operation described above. Further, as shown in FIG. 7, when a predetermined key zone is selected, the operator can adjust a color adjustment quantity indicated by a bar graph in the figure to increase the quantity by 50% by performing the operation described above.

An ink-supply-quantity control method by the ink control apparatus 11 in the offset printer according to this embodiment is explained below using a flowchart in FIG. 8. In the ink-supply-quantity control method by the ink control apparatus 11, pre-print preparation such as attachment of a printing plate to a plate cylinder and pre-inking is completed at step S11 as shown in FIG. 9. At step S12, the operator operates a not-shown test print switch to carry out test print of an image that is set based on the PPF data. The operator carries out this test print work by controlling the ink clearance controllers and the ink fountain roller rotation controllers of the ink supply devices 102, 202, 302, and 402 according to a reference ink supply quantity that is set based on the PPF data and actuating the printing units 101, 201, 301, and 401.

When this test print ends, at step S13, the operator visually evaluates a print image test-printed and judges whether color adjustment work is necessary. When it is judged that color adjustment work for the print image test-printed is unnecessary, the operator shifts to step S26 and operates a not-shown commercial printing switch to carry out commercial printing. On the other hand, when it is judged that color adjustment work for the print image test-printed is necessary, the operator starts color adjustment work for the print image at step S14.

First, at step S14, the operator displays an image that is set based on the PPF data, i.e., a pattern of fruits on the image display screen 31 of the operation unit 21. At step S15, when the operator desires to adjust a color of a predetermined fruit in the pattern of the fruits displayed, the operator selects ink key zones among the ink key zones No. 7 to 14, in which the fruit is present, with a finger tip. Subsequently, at step S16, the operator operates the switch by unit 45 and, then, touches the adjustment switches 41a, 41b, 42a, 42b, 43a, 43b, 44a, and 44b in ink colors, which the operator desires to adjust, to input an indication value for color adjustment. Then, adjustment quantities for the ink colors are displayed in the display sections 36, 37, 38, and 39 of the color-adjustment-quantity operation screen 33. At this point, when the operator desires to reset the indication value for color adjustment set and perform adjustment again, the operator operates the reset switch 40.

At step S17, the operator judges whether there is a portion to which color adjustment is applied other than the specific fruit. When there is a portion to which color adjustment is applied other than the specific fruit, the operator returns to step S14 and selects a specific ink key zone in the image display screen 31. In the same manner as the above description, the operator inputs an indication value using the adjustment switches 41a, 41b, 42a, 42b, 43a, 43b, 44a, and 44b in the color-adjustment-quantity operation screen 33. At this point, when ink key zones selected for color adjustment overlap, an indication value adjusted last is processed preferentially. Alternatively, all indication values may be averaged and processed.

On the other hand, when it is judged at step S17 that there is no portion to which color adjustment is applied other than the specific fruit, at step S18, the operator judges whether a ratio of the color adjustment quantity adjusted for each of the ink colors is changed. When it is unnecessary to change the ratio of the color adjustment quantity, the operator shifts to step S23. On the other hand, when it is necessary to change the ratio of the color adjustment quantity, the operator executes processing for the change at step S19 and subsequent steps. At step S19, the operator selects one of black (K), cyan (C), magenta (M), and yellow (Y) as the four ink components using the color selection switch 47 in the color-adjustment-quantity operation screen 33. At step S20, the operator selects an ink key zone in which a ratio is changed. At step S21, the operator operates the ratio-change bar switch 48 to set a ratio of a color adjustment quantity for the ink color selected. Then, an adjustment ratio of the ink colors is displayed in the display sections 36, 37, 38, and 39 of the color-adjustment-quantity display screen 32.

At step S22, the operator judges whether there is a portion in which a ratio of a color adjustment quantity is changed other than the specific fruit. When there is a portion in which a ratio of a color adjustment quantity is performed, the operator returns to step S19 and repeats the processing described above. On the other hand, when there is no portion in which a ratio of a quantity of color change is changed, at step S23, the operator operates the transmission switch 46 to collectively transmit the indication values of the adjustment quantity for the ink key zones set to the arithmetic unit 12. When the color adjustment work is performed a plurality of times, a color adjustment quantity added with an increase/decrease for each of black (K), cyan (C), magenta (M), and yellow (Y) as the ink components (a total quantity of color adjustment quantities) is displayed on the color-adjustment-quantity display screen 32. The operator can collectively transmits the total quantity of the color adjustment quantities displayed on the color-adjustment-quantity display screen 32 to the arithmetic unit 12 by operating the transmission switch 46. Then, at step S24, the arithmetic unit 12 calculates a quantity of ink increase/decrease for each of the ink components in association with the ink key zones selected based on the indication values of color adjustment. The arithmetic unit 12 adds this quantity of ink increase/decrease to an ink supply quantity for each of the ink components in each of the ink key zones and changes the ink supply quantity for each of the ink components. The arithmetic unit 12 calculates variations in openings of the ink keys 105, 205, 305, and 405 in the ink key zone according to the ink supply quantity for each of the ink components. At step S25, the arithmetic unit 12 changes ink clearances of the ink keys 105, 205, 305, and 405 in the ink supply devices 102, 202, 302, and 402 based on the ink clearance for each of the ink components changed.

Thereafter, the operator returns to step S12 and operates a test print button to carry out test print. The operator carries out this test print work by controlling the ink clearance controllers and the ink fountain roller rotation controllers of the ink supply devices 102, 202, 302, and 402 according to the ink supply quantity changed by the color adjustment work and actuating the printing units 101, 201, 301, and 401.

When the second test print ends, at step S13, the operator visually evaluates a print image test-printed and judges whether color adjustment work is necessary. When it is judged again that color adjustment work is necessary for the print image test-printed, as described above, the operator starts color adjustment work for the print image at step S14 and subsequent steps. On the other hand, when it is judged that color adjustment work for the print image is unnecessary, the operator shifts to step S26, carries out commercial printing, and completes the work.

In the offset printer including the ink control apparatus according to the first embodiment, the ink supply devices 102, 202, 302, and 402 include the ink keys 105, 205, 305, and 405 that are capable of adjusting an ink supply quantity for each of a plurality of ink key zones sectioned in the print width direction. The offset printer includes the operation unit 21 with which the operator is capable of selecting a plurality of ink key zones in which color adjustment is performed from the image display screen 31 that displays a print image based on PPF data and is capable of inputting an indication value for a color adjustment quantity using the color-adjustment-quantity operation screen 33. The arithmetic unit 12 sets a supply quantity for each of the ink components in the ink key zones selected based on reference data of an image. On the other hand, the arithmetic unit 12 sets an increase/decrease for each of the ink components in the ink key zones selected based on the indication value for the color adjustment quantity. The arithmetic unit 12 adds the increase/decrease to the supply quantity for each of the ink components to change the supply quantity for each of the ink components and controls the ink supply devices 102, 202, 302, and 402 according to the supply quantity for each of the ink components changed.

Therefore, when the operator inputs an indication value for a color adjustment quantity for the ink key zones selected for performing color adjustment, an increase/decrease for each of the ink components in each of the ink zones is set. Thus, it is possible to easily adjust an ink supply quantity for each of the ink key zones sectioned in the print width direction. It is also possible to realize improvement of workability by realizing simplification of color adjustment work. Moreover, it is possible to reduce burdens on the operator.

In this embodiment, the operator selects two or more ink areas where color adjustment is performed from an image displayed on the image display screen 31. Color adjustment quantities for the ink zones selected are set as optimum color adjustment quantities different for each of the ink key zones based on an identical indication value, an image area ratio, and the number of revolutions of the ink fountain roller. This makes it possible to adjust ink supply quantities to the ink areas having different image area ratio s easily and in a short time and improve workability.

In this case, even if the operator selects a plurality of ink key zones and indicates an indication value for the same color adjustment quantity for the ink key zones selected, it is impossible to set a proper ink supply quantity because an image area ratio of an image is different for each of the ink key zones. Thus, in the first embodiment, identical indication values for color adjustment quantities indicated for the ink key zones are calculated as optimum values different for each of the ink key zones using an image area ratio, the number of revolutions of the ink fountain roller, and a control gain parameter and an optimum ink supply quantity is set. This makes it possible to set a proper ink supply quantity.

In the offset printer including the ink control apparatus according to the first embodiment, the color-adjustment-quantity display screen 32 including the four display sections 36, 37, 38, and 39 that display a color adjustment quantity for each of ink key zones of an image is provided in association with the black (K), cyan (C), magenta (M), and yellow (Y) as the four ink colors. All adjustment quantities subjected to color adjustment work for each of the ink key zones selected are added up to display the adjustment quantities as a total quantity of color adjustment quantities for the ink components. When the operator operates the transmission switch 46, the total quantity of the color adjustment quantities displayed on the color-adjustment-quantity display screen 32 is collectively transmitted to the arithmetic unit 12. Therefore, it is possible to perform color adjustment work for each of the ink key zones a plurality of times, correct the color adjustment quantities, and reset the color adjustment quantities. This makes it possible to improve workability.

In the first embodiment, it is possible to change a ratio of a color adjustment quantity adjusted for each of the ink colors using the operation unit 21. Therefore, the operator selects one color among the four ink components using the color selection switch 47 and operates the ratio-change bar switch 48. In this way, the operator can change a ratio of a color adjustment quantity for the selected ink color. In this case, as shown in FIG. 6, when an ink key zone is not selected, the operator can adjust an overall color adjustment quantity for all the ink key zones. When an ink key zone is selected, the operator can adjust a quantity of adjustment of the ink key zone selected. As a result, the operator can easily adjust a density of an image.

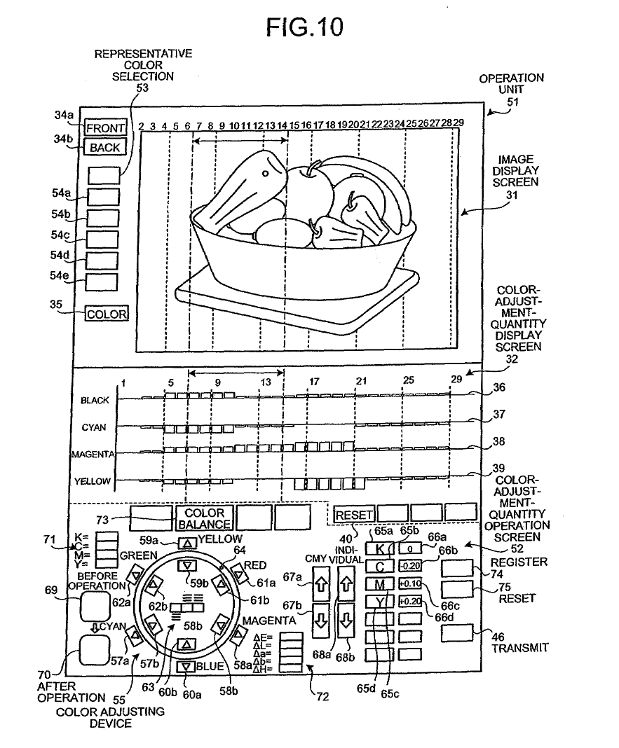

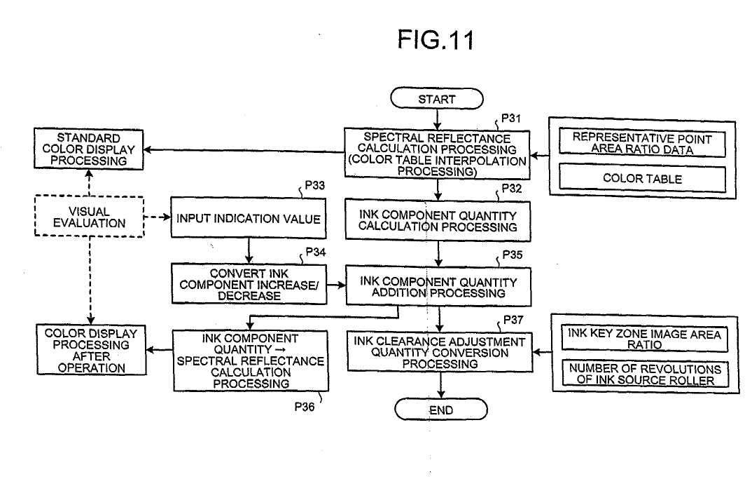

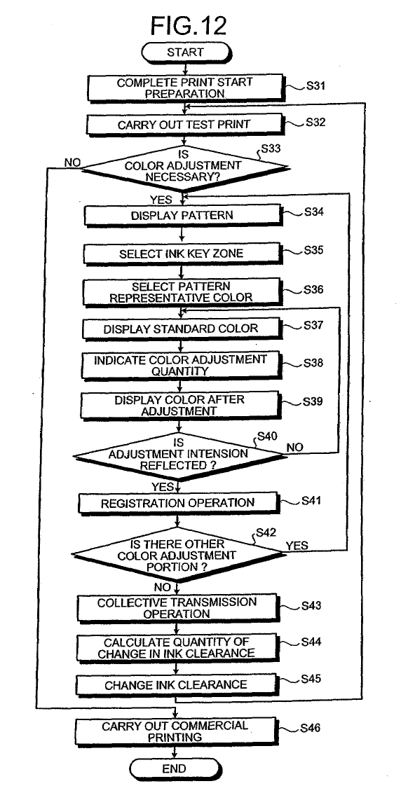

FIG. 10 is a schematic of an operation unit of an ink control apparatus in a printer according to a second embodiment of the present invention. FIG. 11 is a schematic of the ink control apparatus in the printer according to the second embodiment. FIG. 12 is a flowchart of ink supply quantity control by the ink control apparatus in the printer according to the second embodiment. An overall structure of the offset printer according to this embodiment is substantially the same as that in the first embodiment described above and is explained using FIGS. 3 and 9. Members having functions same as those explained in the first embodiment are denoted by identical reference numerals and signs and redundant explanations of the members are omitted.

In an offset printer including the ink control apparatus according to the second embodiment, as shown in FIG. 10, an operation unit 51 for operating the offset printer according this embodiment is a display of a touch panel type. An operator is capable of operating the operation unit 51 by touching a screen thereof with a finger tip. The operation unit 51 has the image display screen 31 that displays a print pattern image based on the PPF data by sectioning the print pattern image into ink key zones, the color-adjustment-quantity display screen 32 that displays a set color adjustment quantity for each of the ink key zones, and a color-adjustment-quantity operation screen 52 that displays the color adjustment quantity.

The image display screen 31 can display a print image based on the PPF data. In a side part of the image display screen 31, the sheet selection switches 34a and 34b for selecting the front and the back of a print sheet and the color selection switch 35 for displaying an image with one of black (K), cyan (C), magenta (M), and yellow (Y) as four ink colors are provided. Further, in the side part of the image display screen 31, a representative-color selection switch 53 for selecting a representative image (a representative color) in the image displayed on the image display screen 31 is provided. Moreover, five representative-color display sections (storing units) 54a, 54b, 54c, 54d, and 54e that store and display the representative color selected are provided.

Therefore, for example, when an image of a large number of fruits in a basket is displayed on the image display screen 31 and the operator desires to adjust a color of a specific fruit in the image of the fruits, the operator can set ink key zones, in which color adjustment is performed, by touching the ink key zones No. 7 to 14, in which the fruit is present, with a finger tip to select the ink key zone. When the operator desires to perform color adjustment for a specific portion of the fruit, the operator can display an image of the specific portion on one of the five representative-color display sections 54a, 54b, 54c, 54d, and 54e and store the image by touching the representative-color selection switch 53 and, then, touching the specific portion (a representative image) of the fruit with a fingertip. In this case, it is possible to store five representative images. The operator can also display the image of the specific portion on one of the representative-color display sections 54a, 54b, 54c, 54d, and 54e and store the image by touching the specific portion (the representative image) of the fruit with a ringer tip and, then, touching the representative-color selection switch 53.

In the color-adjustment-quantity display screen 32, the four display sections 36, 37, 38, and 39 that display a color adjustment quantity for each of the ink key zones of the image are provided in association with black (K), cyan (C), magenta (M), and yellow (Y) as the four ink colors. The reset switches 40 for resetting adjustment quantities of adjusted respective ink colors to zero are provided below the color-adjustment-quantity display screen 32.

The color-adjustment-quantity operation screen 52 includes a color adjusting device 55 for setting color adjustment quantities for cyan (C), magenta (M), and yellow (M) as three ink colors. The color adjusting device 55 includes adjustment switches 57a, 57b, 58a, 58b, 59a, and 59b provided on the inner side and the outer side of a ring 56 and used for increasing and decreasing color adjustment quantities of cyan (C), magenta (M), and yellow (Y) and adjustment switches 60a, 60b, 61a, 61b, 62a, and 62b for increasing and decreasing color adjustment quantities of blue, red, and green, which are intermediate colors of cyan (C), magenta (M), and yellow (Y). A graph display section 63 that displays the color adjustment quantities for cyan (C), magenta (M), and yellow (Y) as a graph is provided in the center of the ring 56. A degree display section 64 that displays a degree of the color adjustment is provided in the ring 56.

In a lateral direction of the color adjusting device 55, selection switches 65a, 65b, 65c, and 65d corresponding to cyan (C), magenta (M), yellow (Y), and black (K) are provided and control-quantity display sections 66a, 66b, 66c, and 66d that display control quantities (adjustment quantities) of the respective colors are provided. Density adjustment switches 67a and 67b for increasing and decreasing cyan (C), magenta (M), and yellow (Y) by the same quantity, i.e., adjusting densities thereof are provided and individual adjustment switches 68a and 68b for individually increasing and decreasing cyan (C), magenta (M), yellow (Y), and black (K) are provided next to the selection switches and the control-quantity display sections.

Beside the color adjusting device 55, a pre-operation display section (a pre-adjustment display section) 69 that displays a representative color (a print color of a representative image) before color adjustment operation is performed and a post-operation display section (a post-adjustment display section) 70 that displays a representative color (a representative image) after color adjustment operation is performed are provided. In this case, it is possible to display a representative color based on PPF data in the pre-operation display section 69. It is possible to display a representative color adjusted by the color adjusting device 55 on the post-operation display section 70. The representative colors displayed on the pre-operation display section 69 and the post-operation display section 70 are representative colors of a representative image selected with the representative-color selection switch 53. An area-ratio display section 71 that displays area ratios of respective colors in this representative image is provided above the pre-operation display section 69.

The color-adjustment-quantity operation screen 52 includes a color-difference display section 72 that displays, in the representative image, a difference between a print color before adjustment displayed on the pre-operation display section 69 and a print color after adjustment displayed on the post-operation display section 70 using a deviation value in a CIELAB color space. In the color-difference display section 72, a deviation Δa in an “a” axis direction, a deviation Δb in a “b” axis direction, a color difference ΔE between “a” and “b” and L, a deviation ΔL (or brightness) in an L axis direction crossing the “a” axis and the “b” axis, and a deviation ΔH of a hue are displayed. Color balance switches 73 are provided above the color-adjustment-quantity operation screen 52. A registration switch 74, a reset switch 75, and a transmission switch 46 are provided in a side part of the color-adjustment-quantity operation screen 52.

Therefore, when an ink key zone in which color adjustment is performed is set and a representative image is selected with the representative-color selection switch 53 in the image display screen 31 (or the color-adjustment-quantity display screen 32), the operator touches any one of the adjustment switches 57a, 57b, 58a, 58b, 59a, and 59b and the adjustment switches 60a, 60b, 61a, 61b, 62a, and 62b of the color-adjustment-quantity operation screen 52. In this way, the operator can input an indication value (an increase/decrease value or a decrease value) of color adjustment for each of the ink colors (cyan, magenta, and yellow) or the intermediate colors of the ink colors (blue, red, and green). In this case, for example, when the operator operates the adjustment switches 61a and 61b corresponding to red, since cyan and yellow of the ink colors are simultaneously adjusted, operation loads are reduced. Then, according to the operation of the respective adjustment switches 57a, 57b, 58a, 58b, 59a, 59b, 60a, 60b, 61a, 61b, 62a, and 62b, the indication value, i.e., an increase/decrease for each of black (K), cyan (C), magenta (M), and yellow (Y) as the ink components is displayed on the control-quantity display sections 66a, 66b, 66c, and 66d as a numerical value. The increase/decrease is also displayed on the color-adjustment-quantity display screen 32 as a bar graph.

In the color-adjustment-quantity operation screen 52, the representative color of the representative image based on the PPF data is displayed on the pre-operation display section 69 and the representative color of the representative image adjusted by the color adjusting device 55 is displayed on the post-operation display section 70. The operator can perform color adjustment while comparing the representative colors displayed on the pre-operation display section 69 and the post-operation display section 70. Moreover, the operator can perform color adjustment while looking at the control-quantity display sections 66a, 66b, 66c, and 66d, the area-ratio display section 71, and a color-difference display section 72 as standards.

When color adjustment is applied to a plurality of ink key zones or a plurality of representative images, it is possible to store an indication value for a color adjustment quantity at that point in the color-adjustment-quantity display screen 32 by operating the registration switch 74 every time color adjustment is performed. It is possible to cancel the indication value for the color adjustment quantity at that point by operating the reset switch 75.

Processing by the ink control apparatus 11 controlled by the operation unit 51 is explained in detail. When the operator inputs an indication value (an increase/decrease) of color adjustment with the operation unit 51, the indication value for color adjustment is outputted to the arithmetic unit 12 of the ink control apparatus 11. An ink supply quantity for each of the ink components is set.

As shown in FIG. 11, in a processing block P31, when a representative point (a representative image) is selected in the image display screen 31 of the operation unit 21, the ink control apparatus 11 acquires halftone area ratio data of the representative point from the PPF data, calculates a spectral reflectance using a color table in which a relation between a halftone area ratio and a spectral reflectance is described, and calculates a color value (a Lab value, etc.) of a standard color. In a processing block P32, the ink control apparatus 11 calculates an ink supply quantity for each of the ink components based on the spectral reflectance of the representative point calculated.

The ink control apparatus 11 calculates the ink supply quantity for each of the ink components before adjustment using Equation 1 below. The ink control apparatus 11 uses the spectral reflectance at the halftone area ratio of the representative point calculated as described above to convert the spectral reflectance into a spectral density. The ink control apparatus 11 determines a spectral density of a single color serving as a reference from the halftone area ratio of the representative point and substitutes the spectral density in Equation 1. The ink control apparatus 11 performs a multiple regression calculation using Equation 1 to calculate ink component quantities tc, tm, ty, and tk for each of the ink components.

$$[ \begin{matrix}{D}_{( 380 nm )} \\ {D}_{( 390 nm )} \\ ⋮ \\ {D}_{( 860 nm )}\end{matrix} ] = [ \begin{matrix}{Dc}_{( 380 nm )} & {Dm}_{( 380 nm )} & {Dy}_{( 380 nm )} & {Dk}_{( 380 nm )} \\ {Dc}_{( 390 nm )} & {Dm}_{( 390 nm )} & {Dy}_{( 390 nm )} & {Dk}_{( 390 nm )} \\ ⋮ & ⋮ & ⋮ & ⋮ \\ {Dc}_{( 860 nm )} & {Dm}_{( 860 nm )} & {Dy}_{( 860 nm )} & {Dk}_{( 860 nm )}\end{matrix} ] \times [ \begin{matrix}{t}_{c} \\ {t}_{m} \\ {t}_{y} \\ {t}_{k}\end{matrix} ]$$

D(λ)=−log(R(λ)/Rzero(λ)): Spectral density of a designated area ratio

R(λ): Reflectance at the designated area ratio

Rzero(λ): Reflectance at an area ratio zero (a white paper portion)

Dc(λ): Spectral density of a reference cyan color stored in advance

Dm(λ): Spectral density of a reference magenta color stored in advance

Dy(λ): Spectral density of a reference yellow color stored in advance

Dk(λ): Spectral density of a reference black color stored in advance

tc: Ink component quantity of cyan

tm: Ink component quantity of magenta

ty: Ink component quantity of yellow

tk: Ink component quantity of black

On the other hand, the operator performs visual evaluation looking at the pre-operation display section 69 and the post-operation display section 70 of the color-adjustment-quantity operation screen 52 in the operation unit 51 and performs determination of an indication value. In a processing block P33, the operator inputs an indication value for color adjustment using the color adjusting device 55 of the operation unit 51. Then, in a processing block P34, the ink control apparatus 11 sets a quantity of ink increase/decrease for each of the ink components based on the indication value for color adjustment (the ink-increase/decrease setting unit 17). In a processing block P35, the ink control apparatus 11 adds a quantity of ink component increase/decrease to the ink component quantities to, tm, ty, and tk calculated as described above (the ink increase/decrease adding unit 18). In a processing block P36, the ink control apparatus 11 calculates a spectral reflectance backward from the ink component quantities using the ink component quantities added with the quantity of ink component increase/decrease. The ink control apparatus 11 calculates a representative color after color adjustment and displays the representative color on the post-operation display section 70. The ink control apparatus 11 displays the differences between the color value of the reference color and the color value after adjustment calculated as described above (the deviation Δa in the “a” axis direction, the deviation Δb in the “b” axis direction, the color difference ΔE between “a” and “b” and L, the deviation ΔL (or brightness) in the L axis direction crossing the “a” axis and the “b” axis, and the deviation ΔH of a hue) are displayed. It is also possible to determine an indication value with these values as references. On the other hand, in a processing block P37, the ink control apparatus 11 controls ink supply quantities supplied by the large number of the ink keys 105, 205, 305, and 405 in the ink supply devices 102, 202, 302, and 402 according to an ink supply quantity for each of the ink components changed (the ink-supply-quantity control unit 19).

An ink-supply-quantity control method by the ink control apparatus 11 in the offset printer according to this embodiment is explained below using a flowchart in FIG. 12. In the ink-supply-quantity control method by the ink control apparatus 11, pre-print preparation such as attachment of a printing plate to a plate cylinder and pre-inking is completed at step S31 as shown in FIG. 12. At step S32, the operator operates a not-shown test print switch to carry out test print of an image that is set based on the PPF data. The operator carries out this test print work by controlling the ink clearance controllers and the ink fountain roller rotation controllers of the ink supply devices 102, 202, 302, and 402 according to a reference ink supply quantity that is set based on the PPF data and actuating the printing unit 101, 201, 301, and 401.

When this test print ends, at step S33, the operator visually evaluates a print image test-printed and judges whether color adjustment work is necessary. When it is judged that color adjustment work for the print image test-printed is unnecessary, the operator shifts to step S46 and operates a not-shown commercial printing switch to carry out commercial printing. On the other hand, when it is judged that color adjustment work for the print image test-printed is necessary, the operator starts color adjustment work for the print image at step S34 and subsequent steps.

First, at step S34, the operator displays an image that is set based on the PPF data, i.e., a pattern of fruits on the image display screen 31 of the operation unit 51. At step S35, when the operator desires to adjust a color of a predetermined fruit in the pattern of the fruits displayed, the operator selects ink key zones among the ink key zones No. 7 to 14, in which the fruit is present, with a finger tip. Subsequently, at step S36, when the operator desires to perform color adjustment for a specific portion of the fruit in the ink key zones selected, the operator touches the representative-color selection switch 53 and, then, touches the specific portion (a representative image) in the fruit with a fingertip. Then, an image (color) of the specific portion of the fruit selected is displayed on the representative-color display section 54a and stored. At step S37, a representative color of the representative image based on the PPF data is displayed on the pre-operation display section 69 as a standard color.

At step S38, the operator operates the color balance switch 73 and, then, touches the adjustment switches 57a, 57b, 58a, 58b, 59a, 59b, 60a, 60b, 61a, 61b, 62a, and 62b in the color adjusting device 55 of the color-adjustment-quantity operation screen 52 to input an indication value for color adjustment. Then, the representative color of the representative image adjusted by the color adjusting device 55 is displayed on the post-operation display section 70. At this point, when the operator desires to reset the indication value for color adjustment set and performs adjustment again, the operator operates the reset switch 40.

At step S40, the operator compares the color before operation displayed on the pre-operation display section 69 and the color after adjustment displayed on the post-operation display section 70 and judges whether an adjustment intention of the operator is sufficiently reflected on the color after adjustment. When it is judged that the color after adjustment displayed on the post-operation display section 70 sufficiently reflects the adjustment intention of the operator, at step S41, the operator operates the registration switch 74 to decide the color. Then, adjustment quantities of the respective ink colors are displayed on the display sections 36, 37, 38, and 39 of the color-adjustment-quantity operation screen 52. On the other hand, when it is judged at step S40 that the color after adjustment displayed on the post-operation display section 70 does not sufficiently reflect the adjustment intention of the operator, the operator returns to step S37 and repeats the color adjustment work. In this case, when the operator is well-experienced in the color adjustment work, the operator can perform the color adjustment work by operating the adjustment switches 57a, 57b, 58a, 58b, 59a, 59b, 60a, 60b, 61a, 61b, 62a, and 62b without selecting a representative color.

At step S42, the operator judges whether there is a portion to which color adjustment is applied other than the specific fruit. When there is a portion to which color adjustment is applied other than the specific fruit, the operator returns to step S34. The operator selects a specific ink key zone in the image display screen 31 and inputs an indication value using the color adjusting device 55 in the color-adjustment-quantity operation screen 52 in the same manner as the above description. At this point, when ink key zones selected for color adjustment overlap, an indication value adjusted last is processed preferentially.

On the other hand, when it is judged at step S42 that there is no portion to which color adjustment is applied other than the specific fruit, at step S43, the operator operates the transmission switch 46 and collectively transmits indication values of adjustment quantities for the ink key zones set to the arithmetic unit 12. Then, at step S44, the arithmetic unit 12 calculates a quantity of ink increase/decrease for each of the ink components in association with the ink key zones selected based on the indication values of color adjustment. The arithmetic unit 12 adds this quantity of ink increase/decrease to an ink supply quantity for each of the ink components in each of the ink key zones and changes the ink supply quantity for each of the ink components. The arithmetic unit 12 calculates variations in openings of the ink keys 105, 205, 305, and 405 in the ink key zone according to the ink supply quantity for each of the ink components. At step S45, the arithmetic unit 12 changes ink clearances of the ink keys 105, 205, 305, and 405 in the ink supply devices 102, 202, 302, and 402 based on the ink clearance for each of the ink components changed.

Thereafter, the operator returns to step S32 and carries out test print by operating the test print button. The operator carries out this test print work by controlling the ink clearance controllers and the ink fountain roller rotation controllers of the ink supply devices 102, 202, 302, and 402 according to the ink supply quantity changed by the color adjustment work and actuating the printing unit 101, 201, 301, and 401.

When the second test print ends, at step S33, the operator visually evaluates a print image test-printed and judges whether color adjustment work is necessary. When it is judged again that color adjustment work is necessary for the print image test-printed, as described above, the operator starts color adjustment work for the print image at step S34 and subsequent steps. At this point, when the image to be subjected to color adjustment is stored in the representative-color display section 54a, the operator touches the representative-color display section 54a. Consequently, a representative image to be subjected to color adjustment is automatically selected. On the other hand, when it is judged that color adjustment work for the print image is unnecessary, the operator shifts to step S46, carries out commercial printing, and completes the work.

As described above, in the offset printer including the ink control apparatus according to the second embodiment, the operation unit 51 including the image display screen 31 that displays an image based on PPF data by sectioning the image into ink key zones, the color-adjustment-quantity display screen 32 that displays a set color adjustment quantity for each of the ink key zones, and the color-adjustment-quantity operation screen 52 that performs color adjustment is provided. The operator selects an ink key zone in which color adjustment is performed from the image displayed on the image display screen 31 and sets, for each of the ink key zones, a color adjustment quantity for the ink key zone selected by the color-adjustment-quantity operation screen 52.

Therefore, when the operator inputs an indication value for a color adjustment quantity for the ink key zones selected for performing color adjustment, an increase/decrease for each of the ink components in each of the ink zones is set. Thus, it is possible to easily adjust an ink supply quantity for each of the ink key zones sectioned in the print width direction. It is also possible to realize improvement of workability by realizing simplification of color adjustment work. Moreover, it is possible to reduce burdens on the operator.

In this embodiment, the representative-color selection switch 53 for selecting a representative image (a representative color) in a print image displayed on the image display screen 31 is provided. In addition, the representative-color display sections 54a, 54b, 54c, 54d, and 54e that store and display the representative color selected is provided. Therefore, it is possible to easily adjust, in particular, a predetermined color of a predetermined portion to which the operator desires to apply color adjustment by selecting a representative image in an ink key zone. It is also possible to easily perform color adjustment for pixels in the same portion by storing the representative image selected.

Moreover, in this embodiment, a representative color before color adjustment is displayed on the pre-operation display section 69 of the color-adjustment-quantity operation screen 52. When the operator operates the color adjusting device 55 to input an indication value for color adjustment, a representative color after adjustment is displayed on the post-operation display section 70. Therefore, the operator can check whether an adjustment intention of the operator is reflected on the representative color after color adjustment by comparing the representative color before color adjustment displayed on the pre-operation display section 69 and the representative color after color adjustment displayed on the post-operation display section 70. It is possible to reduce a print time and work cost by reducing the number of times of test print.

In this embodiment, the color-difference display section 72 that displays, in the representative image selected by the color-adjustment-quantity operation screen 52, a difference between a print color before adjustment based on image information and a print color after adjustment based on a color adjustment quantity using a deviation value in a CIELAB color space is provided. Therefore, the operator can perform color adjustment for a print color while checking the deviation value on the color-difference display section 72 and improve workability.

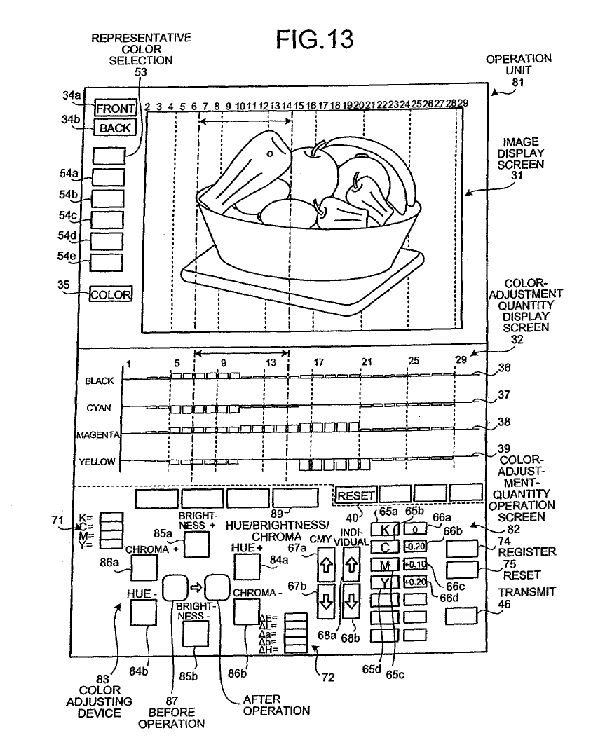

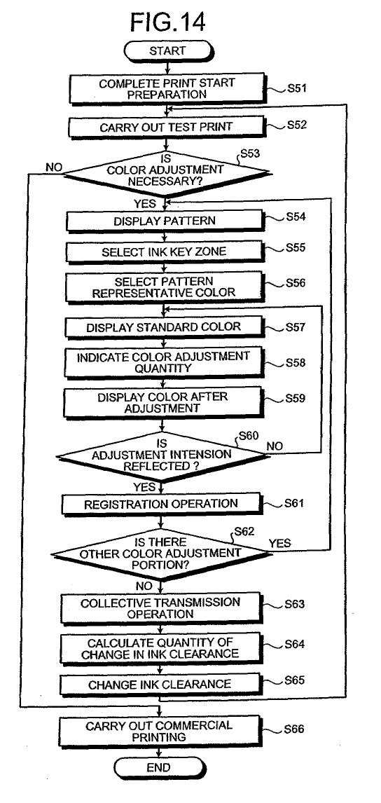

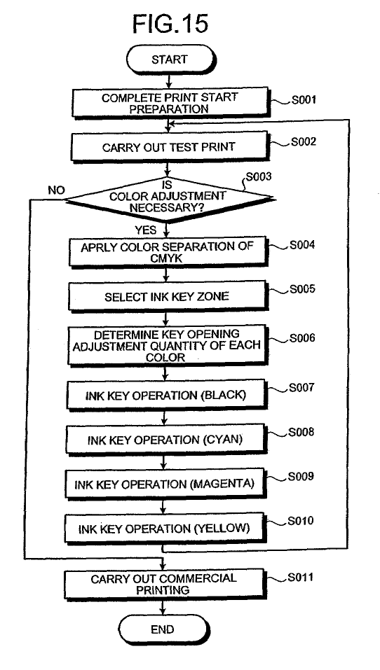

FIG. 13 is a schematic of an operation unit of an ink control apparatus in a printer according to a third aspect of the present invention. FIG. 14 is a flowchart of ink supply quantity control by the ink control apparatus in the printer according to the third embodiment. An overall structure of the offset printer according to this embodiment is substantially the same as that in the first embodiment described above and is explained using FIGS. 3 and 9. Members having functions same as those explained in the first embodiment are denoted by identical reference numerals and signs and redundant explanations of the members are omitted.

In an offset printer including the ink control apparatus according to the third embodiment, as shown in FIG. 13, an operation unit 81 for operating the offset printer according this embodiment is a display of a touch panel type. An operator is capable of operating the operation unit 81 by touching a screen thereof with a finger tip. The operation unit 81 has the image display screen 31 that displays a print pattern image based on the PPF data by sectioning the print pattern image into ink key zones, the color-adjustment-quantity display screen 32 that displays a set color adjustment quantity for each of the ink key zones, and a color-adjustment-quantity operation screen 82 that displays the color adjustment quantity.

The image display screen 31 can display a print image based on the PPF data. In a side part of the image display screen 31, the sheet selection switches 34a and 34b for selecting the front and the back of a print sheet, the color selection switch 35 for displaying an image with one of black (K), cyan (C), magenta (M), and yellow (Y) as four ink colors, the representative-color selection switch 53 for selecting a representative image (a representative color) in the image displayed on the image display screen 31, and the five representative-color display sections (storing units) 54a, 54b, 54c, 54d, and 54e that store and display the representative color selected are provided.

Therefore, for example, the operator can set an ink key zone in which color adjustment is performed by touching and selecting the ink key zones No. 7 to 14, in which a fruit to which the operator desires to apply color adjustment is present, with a fingertip. When the operator desires to perform color adjustment for a specific portion of the fruit, the operator can display an image of the specific portion on one of the five representative-color display sections 54a, 54b, 54c, 54d, and 54e and store the image by touching the representative-color selection switch 53 and, then, touching the specific portion (a representative image) of the fruit with a fingertip.

In the color-adjustment-quantity display screen 32, the four display sections 36, 37, 38, and 39 that display a color adjustment quantity for each of the ink key zones of the image are provided in association with black (K), cyan (C), magenta (M), and yellow (Y) as the four ink colors. The reset switch 40 for resetting adjustment quantities of the respective ink colors adjusted to zero is also provided.

In the color-adjustment-quantity operation screen 82, a color adjusting device 83 for setting a color adjustment quantity based on a hue, brightness, and chroma is provided in association with the cyan (C), magenta (M), and yellow (Y) as the ink colors. The color adjusting device 83 includes adjustment switches 84a, 84b, 85a, 85b, 86a, and 86b for increasing and decreasing color adjustment quantities for a hue, brightness, and chroma. A pre-operation display section 87 that displays a representative color (a representative image) before color adjustment operation is performed and a post-operation display section 88 that displays a representative color (a representative image) after color adjustment operation is performed are provided in the center of the adjustment switches 84a, 84b, 85a, 85b, 86a, and 86b. In this case, it is possible to display a representative color based on the PPF data on the pre-operation display section 87 and display a representative color adjusted by the color adjusting device 55 on the post-operation display section 88.

The color-adjustment-quantity operation screen 82 includes the area-ratio display section 71 that displays area ratios of colors in the representative image. The color-adjustment-quantity operation screen 82 includes the color-difference display section 72 that displays, in the representative image, a difference between a print color before adjustment displayed on the pre-operation display section 69 and a print color after adjustment displayed on the post-operation display section 70 using a deviation value in a CIELAB color space.

In a lateral direction of the color adjusting device 55, the selection switches 65a, 65b, 65c, and 65d corresponding to cyan (C), magenta (M), yellow (Y), and black (K), the control-quantity display sections 66a, 66b, 66c, and 66d that display control quantities (adjustment quantities) of the respective colors, the density adjustment switches 67a and 67b for increasing and decreasing cyan (C), magenta (M), and yellow (Y) by the same quantity, i.e., adjusting densities thereof are provided, and the individual adjustment switches 68a and 68b for individually increasing and decreasing cyan (C), magenta (M), yellow (Y), and black (K) are provided.

Above the color-adjustment-quantity operation screen 82, hue/brightness/chroma switches 89 are provided. In a side part of the color-adjustment-quantity operation screen 82, the registration switch 74, the reset switch 75, and the transmission switch 46 are provided.

Therefore, when an ink key zone in which color adjustment is performed is set and a representative image is selected with the representative-color selection switch 53 in the image display screen 31 (or the color-adjustment-quantity display screen 32), the operator touches any one of the adjustment switches 84a, 84b, 85a, 85b, 86a, and 86b of the color adjusting device 83 in the color-adjustment-quantity operation screen 82. In this way, the operator can input an indication value (an increase/decrease value or a decrease value) for color adjustment for each of a hue, brightness, and chroma. Then, according to the operation of the respective adjustment switches 84a, 84b, 85a, 85b, 86a, and 86b, the indication value, i.e., an increase/decrease for each of black (K), cyan (C), magenta (M), and yellow (Y) as the ink components is displayed on the control-quantity display sections 66a, 66b, 66c, and 66d as a numerical value. The increase/decrease is also displayed on the color-adjustment-quantity display screen 32 as a bar graph.

In the color-adjustment-quantity operation screen 82, the representative color of the representative image based on the PPF data is displayed on the pre-operation display section 87 and the representative color of the representative image adjusted by the color adjusting device 83 is displayed on the post-operation display section 88. The operator can perform color adjustment while comparing the representative colors displayed on the pre-operation display section 87 and the post-operation display section 88. Moreover, the operator can perform color adjustment while looking at the control-quantity display sections 66a, 66b, 66c, and 66d, the area-ratio display section 71, and the color-difference display section 72 as standards.

An ink-supply-quantity control method by the ink control apparatus 11 in the offset printer according to this embodiment is explained below using a flowchart in FIG. 14. In the ink-supply-quantity control method by the ink control apparatus 11, pre-print preparation such as attachment of a printing plate to a plate cylinder and pre-inking is completed at step S51 as shown in FIG. 14. At step S52, the operator operates a not-shown test print switch to carry out test print of an image that is set based on the PPF data. The operator carries out this test print work by controlling the ink clearance controllers and the ink fountain roller rotation controllers of the ink supply devices 102, 202, 302, and 402 according to a reference ink supply quantity that is set based on the PPF data and actuating the printing unit 101, 201, 301, and 401.

When this test print ends, at step S53, the operator visually evaluates a print image test-printed and judges whether color adjustment work is necessary. When it is judged that color adjustment work for the print image test-printed is unnecessary, the operator shifts to step S66 and operates a not-shown commercial printing switch to carry out commercial printing. On the other hand, when it is judged that color adjustment work for the print image test-printed is necessary, the operator starts color adjustment work for the print image at step S54 and subsequent steps.

First, at step S54, the operator displays an image that is set based on the PPF data, i.e., a pattern of fruits on the image display screen 31 of the operation unit 81. At step S55, when the operator desires to adjust a color of a predetermined fruit in the pattern of the fruits displayed, the operator selects ink key zones among the ink key zones No. 7 to 14, in which the fruit is present, with a finger tip. Subsequently, at step S56, when the operator desires to apply color adjustment to a specific portion of the bruit in the ink key zones selected, the operator touches the representative-color selection switch 53 and, then, touches the specific portion (a representative image) in the fruit with a fingertip. Then, an image (color) of the specific portion of the fruit selected is displayed on, for example, the representative-color display section 54a and stored. At step S57, the representative color of the representative image based on the PPF data is displayed on the pre-operation display section 87 as a standard color.

At step S58, the operator operates the hue/brightness/chroma switch 89 and, then, touches the adjustment switches 84a, 84b, 85a, 85b, 86a, and 86b in the color adjusting device 83 of the color-adjustment-quantity operation screen 82 with a fingertip to input an indication value for color adjustment. Then, at step S59, the representative color of the representative image adjusted by the color adjusting device 83 is displayed on the post-operation display section 88. At this point, when the operator resets the indication value for color adjustment set and performs adjustment again, the operator operates the reset switch 40.

At step S60, the operator compares the color before operation displayed on the pre-operation display section 87 and the color after adjustment displayed on the post-operation display section 88 and judges whether an adjustment intention of the operator is sufficiently reflected on the color after adjustment. When it is judged that the color after adjustment displayed on the post-operation display section 88 sufficiently reflects the adjustment intention of the operator, at step S61, the operator operates the registration switch 74 to decide the color. Then, adjustment quantities of the respective ink colors are displayed on the display sections 36, 37, 38, and 39 of the color-adjustment-quantity display screen 32. On the other hand, when it is judged at step S60 that the color after adjustment displayed on the post-operation display section 88 does not sufficiently reflect the adjustment intention of the operator, the operator returns to step S57 and repeats the color adjustment work.

At step S62, the operator judges whether there is a portion to which color adjustment is applied other than the specific fruit. When there is a portion to which color adjustment is applied other than the specific fruit, the operator returns to step S54. The operator selects a specific ink key zone in the image display screen 31 and inputs an indication value using the color adjusting device 83 in the color-adjustment-quantity operation screen 82 in the same manner as the above description. At this point, when ink key zones selected for color adjustment overlap, an indication value adjusted last is processed preferentially.

On the other hand, when it is judged at step S62 that there is no portion to which color adjustment is applied other than the specific fruit, at step S63, the operator operates the transmission switch 46 and collectively transmits indication values of adjustment quantities for the ink key zones set to the arithmetic unit 12. Then, at step S64, the arithmetic unit 12 calculates a quantity of ink increase/decrease for each of the ink components in association with the ink key zones selected based on the indication values of color adjustment and changes the ink supply quantity for each of the ink components. The arithmetic unit 12 calculates variations in openings of the ink keys 105, 205, 305, and 405 in the ink key zone according to the ink supply quantity for each of the ink components. At step S65, the arithmetic unit 12 changes ink clearances of the ink keys 105, 205, 305, and 405 in the ink supply devices 102, 202, 302, and 402 based on the ink clearance for each of the ink components changed.

Thereafter, the operator returns to step S52 and carries out test print by operating the test print button. The operator carries out this test print work by controlling the ink clearance controllers and the ink fountain roller rotation controllers of the ink supply devices 102, 202, 302, and 402 according to the ink supply quantity changed by the color adjustment work and actuating the printing unit 101, 201, 301, and 401.

When the second test print ends, at step S53, the operator visually evaluates a print image test-printed and judges whether color adjustment work is necessary. When it is judged again that color adjustment work is necessary for the print image test-printed, as described above, the operator starts color adjustment work for the print image at step S54 and subsequent steps. At this point, when the image to be subjected to color adjustment is stored in the representative-color display section 54a, the operator touches the representative-color display section 54a. Consequently, a representative image to be subjected to color adjustment is automatically selected. On the other hand, when it is judged that color adjustment work for the print image is unnecessary, the operator shifts to step S66, carries out commercial printing, and completes the work.

As described above, in the offset printer including the ink control apparatus according to the third embodiment, the operation unit 81 including the image display screen 31 that displays an image based on PPF data by sectioning the image into ink key zones, the color-adjustment-quantity display screen 32 that displays a set color adjustment quantity for each of the ink key zones, and the color-adjustment-quantity operation screen 82 that performs color adjustment is provided. The operator selects an ink key zone in which color adjustment is performed from the image displayed on the image display screen 31 and sets, for each of the ink key zones, a color adjustment quantity for the ink key zone selected by the color-adjustment-quantity operation screen 52.

Therefore, when the operator inputs an indication value for a color adjustment quantity for the ink key zones selected for performing color adjustment, an increase/decrease for each of the ink components in each of the ink zones is set. Thus, it is possible to easily adjust an ink supply quantity for each of the ink key zones sectioned in the print width direction. It is also possible to realize improvement of workability by realizing simplification of color adjustment work. Moreover, it is possible to reduce burdens on the operator.

In this embodiment, in the color-adjustment-quantity operation screen 82, the color adjusting device 83 for setting a color adjustment quantity based on a hue, brightness, and chroma is provided in association with the cyan (C), magenta (M), and yellow (Y) as the ink colors is provided. Therefore, when ink key zones in which color adjustment is performed are set and a representative image is selected with the representative-color selection switch 53 in the image display screen 31, the operator can input an indication value for color adjustment for each of a hue, brightness, and chroma by touching any one of the adjustment switches 84a, 84b, 85a, 85b, 86a, and 86b of the color adjusting device 83. At this point, a representative color before color adjustment is displayed on the pre-operation display section 87 and a representative color after color adjustment is displayed on the pre-operation display section 88. Consequently, the operator can check whether an adjustment intention of the operator is reflected on the image after color adjustment while comparing the representative colors displayed on the pre-operation display section 69 and the post-operation display section 70. It is possible to reduce a print time and work cost by reducing the number of times of test print.

In the first embodiment, the operator operates the switch by unit 45 and, then, performs color adjustment with the switches corresponding to the four ink colors in the color-adjustment-quantity operation screen 33. In the second embodiment, the operator operates the color balance switch 73 and, then, performs color adjustment with the switches corresponding to the four ink colors and the intermediate colors of the ink colors arranged in a ring shape in the color-adjustment-quantity operation screen 52. In the third embodiment, the operator operates the hue/brightness/chroma switch 89 and, then, performs color adjustment with the hue/brightness/chroma switch in the color-adjustment-quantity operation screen 82. In this case, the first to the third embodiments may be combined as appropriate to constitute an operation unit having the respective functions or any one of the functions and allow the operator to selectively use the functions according to an intention of the operator.

According to an aspect of the present invention, when an operator indicates a color adjustment quantity for the ink area selected for performing color adjustment, a quantity of adjustment for each of ink components in the ink area is automatically set. This makes it possible to easily adjust an ink supply quantity for each of a plurality of ink areas sectioned in the print width direction, realize improvement of workability by realizing simplification of color adjustment work, and reduce burdens on the operator.

According to another aspect of the present invention, it becomes possible to adjust ink supply quantities to the ink areas easily and in a short time and improve workability by setting a different color adjustment quantity for each of the ink areas selected based on an identical indication value and image information.

According to still another aspect of the present invention, it becomes possible to adjust an ink supply quantity to respective ink areas having different image area ratios easily and in a short time and improve workability by setting a color adjustment quantity for each of the ink areas selected based on the indication value, the image area ratio, and the number of revolutions of the ink fountain roller.

According to still another aspect of the present invention, it becomes possible to easily adjust a predetermined color in a predetermined portion by selecting a representative image in an ink area.

According to still another aspect of the present invention, it becomes possible to easily repeat color adjustment for pixels in the same portion by storing a specific representative image in the storing unit.

According to still another aspect of the present invention, the operator can perform color adjustment for an image while comparing a color before adjustment and a color after adjustment and makes it possible to improve workability by displaying the image before adjustment in the pre-adjustment display section and displaying the image color after adjustment in the post-adjustment display section.

According to still another aspect of the present invention, the operator can perform adjustment of a print color while checking the deviation value in the color-difference display section and makes it possible to improve workability.

According to still another aspect of the present invention, it becomes possible to surely set an adjustment quantity for each of the ink components and realize improvement of workability by realizing simplification of color adjustment work.

According to still another aspect of the present invention, the operator can select an ink area while looking at the print pattern image in the image display section or the color adjustment quantity in the color-adjustment-quantity display section and makes it possible to realize improvement of workability.

According to still another aspect of the present invention, it becomes possible to simplify work.

According to still another aspect of the present invention, it becomes possible to set a color adjustment quantity for a representative image, i.e., a variation for each of the ink components in detail and easily adjust the representative image.

According to still another aspect of the present invention, it becomes possible to set a color adjustment quantity for a representative image, i.e., a variation for each of the ink components in detail and easily adjust the representative image.

According to still another aspect of the present invention, it becomes possible to set a color adjustment quantity for an ink component according to a hue, brightness, and chroma with respect to a color to be subjected to color adjustment and indicate the color adjustment quantity easily and in detail to surely change the color adjustment quantity.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An ink control apparatus comprising:
an image display unit that displays a print pattern image based on image information;
an area selecting unit that selects a target ink area where color adjustment is to be performed from the image displayed by the image display unit;
a setting unit that sets a color adjustment quantity for the target ink area;
a quantity display unit that displays, for each of ink areas, the color adjustment quantity set by the setting unit; and
a changing unit that changes, based on the color adjustment quantity displayed by the quantity display unit, an ink supply quantity in the ink area selected by the color-adjustment-ink-area selecting unit.

2. The ink control apparatus according to claim 1, wherein the setting unit sets a color adjustment quantity corresponding to each component of the ink.

3. The ink control apparatus according to claim 1, wherein the setting unit sets color adjustment quantities corresponding to each component of the ink and intermediate colors of the ink components.

4. The ink control apparatus according to claim 1, wherein the setting unit sets a color adjustment quantity for each component of the ink based on a hue, brightness, and chroma.

5. The ink control apparatus according to claim 1, wherein the setting unit adjusts a ratio of a color adjustment quantity displayed on the quantity display unit.

6. The ink control apparatus according to claim 1, wherein the setting unit adjusts, for each of the ink areas, a ratio of a color adjustment quantity displayed on the quantity display unit.

7. The ink control apparatus according to claim 1, wherein
the area selecting unit selects two or more target ink areas, and
the setting unit sets color adjustment quantities for the two or more target ink areas based on a pre-set value.

8. The ink control apparatus according to claim 7, wherein the changing unit sets, for each of the ink areas, a color adjustment quantity for the ink area selected by the area selecting unit based on one or more selected from a pre-set value, an image area ratio, and a number of revolutions of an ink fountain roller.

9. The ink control apparatus according to claim 1, further comprising an image selecting unit that selects a representative image in the target ink area.

10. The ink control apparatus according to claim 9, wherein the image selecting unit includes a storing unit that stores therein the representative image.

11. The ink control apparatus according to claim 9, further comprising:
a pre-adjustment display unit that displays a raw image that is the representative image before the changing unit performs the color adjustment; and
a post-adjustment display unit that displays a processed image that is the representative image after the changing unit performs the color adjustment.

12. The ink control apparatus according to claim 9, further comprising a color-difference display unit that displays, in the representative image, a difference between a raw print color that is a print color before the changing unit performs the color adjustment and a processed print color that is a print color after the changing unit performs the color adjustment using a deviation value in a CIELAB color space.

13. A printer comprising:
an ink supply unit that is capable of adjusting an ink supply quantity for each of ink areas sectioned in a print width direction;
an image display unit that displays a print pattern image based on image information;
an area selecting unit that selects an ink area where color adjustment is performed from the image displayed by the image display unit;
a setting unit that sets a color adjustment quantity for the ink area selected by the area selecting unit;
a quantity display unit that displays, for each of the ink areas, the color adjustment quantity set by the setting unit; and
an changing unit that changes, based on the color adjustment quantity displayed by the quantity display unit, an ink supply quantity in the ink area selected by the area selecting unit.

14. A printing method comprising the steps of, in a printer that is capable of adjusting an ink supply quantity for each of ink areas sectioned in a print width direction:
first displaying including displaying a print pattern image based on image information;
selecting a target ink area where color adjustment is to be performed from the image displayed at the first displaying;
setting a color adjustment quantity for the target ink area;
second displaying including displaying, for each of ink areas, the color adjustment quantity set at the setting; and
changing, based on the color adjustment quantity displayed at the second display, an ink supply quantity in the target ink area.
